(19) United States
(12) Patent Application Publication
(10) Pub. No.: US 2007/0098439 A1
(43) Pub. Date: May 3, 2007

(54) Image forming device

(76) Inventor: Toshiyuki Nakada, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,904

(22) Filed: Oct. 27, 2005

(51) Int. Cl. G03G 15/00

(52) U.S. Cl. 399/117

(57) ABSTRACT

This image forming device 1 is constituted such that a drum unit 10 comprising a photosensitive drum 11 and a development unit 20 comprising a development sleeve 22 disposed opposite the photosensitive drum 11 when the units are coupled together are constituted as separate components, and the drum unit 10 and the development unit 20 are each detachable from the image forming device main body 2.

### FIELD OF THE INVENTION

The present invention relates to an image forming device such as a copier, fax machine, printer, or a multifunction device that combines the functions of the foregoing.

### BACKGROUND INFORMATION

In conventional image forming devices a drum unit comprising a photosensitive drum and a development unit comprising a development sleeve having an axis of rotation parallel to the axis of rotation of the photosensitive drum are coupled and in such state are inserted into and fitted inside an image forming device main body. In a process unit wherein the drum unit and the development unit are coupled, the timing for replacement of the drum unit and of the development unit are different, because the time for replacement of the drum unit is determined by degradation of the photosensitive drum, and time for replacement of the development unit is determined by lack of toner. Thus many image forming devices have been proposed in which the drum unit and the development unit are separate components and the drum unit and the development unit are each provided detachably on the image forming device main body.

Conventionally, for guiding such separate drum unit and development unit to their respective fixed positions within the image forming device main body, in a common configuration, guide grooves for the drum unit and for the development unit are provided on the main body frame, bosses of cylindrical or comparable shape are formed on the drum unit and on the development unit, and by inserting these bosses into the guide grooves and sliding, the units are positioned at their ultimate position.

However, in an image forming device having the drum unit and the development unit as separate components, there is the problem that when the drum unit and the development unit are fitted into the image forming device main body, an operation is required to match the boss parts formed on the drum unit and the development unit onto the groove parts formed in the main body frame, leading to complicated operations. Better operability has been demanded of the development unit in particular, as it must be removed from the image forming device main body each time a paper jam or similar matter is addressed.

As an example of the conventional art for guiding such separate drum unit and development unit to their respective fixed positions within the image forming device main body, a device is publicly known having a common insertion opening for the drum unit and the development unit and comprising a branching guide channel along which the drum unit and the development unit inserted through this common insertion opening are guided to their respective predetermined insertion opening.

Another publicly known device has insertion openings in the main body frame, and when the drum unit and development unit are fitted inside the image forming device main body, the drum unit is inserted through one insertion opening, and the development unit is inserted through the other two insertion openings.

In addition, there is a device constituted such that at least one of the drum unit and the development unit is provided detachably on the image forming device main body, and bosses for example protruding from the drum unit and development unit are inserted into corresponding guide grooves provided in the main body frame.

In all of these conventional examples, guide grooves for the drum unit and for the development unit are provided in the main body frame, bosses of cylindrical or comparable shape are formed on the drum unit and on the development unit, and they are positioned at their ultimate fixed positions by insertion of these bosses into the guide grooves and sliding.

But with such conventional art, in an image forming device in which the drum unit and the development unit are separate components, it is difficult to tell which unit should be inserted through which insertion opening when the drum unit and the development unit are to be fitted inside the image forming device main body, and trying to force one through the wrong insertion opening might cause breakage, etc. This is because the insertion openings for the units are of similar shape and are thus difficult for the operator to distinguish, and because in many cases the composition allows partial insertion even when insertion is made through the wrong insertion hole.

An object of the present invention is to provide an image forming device with improved operability at time of insertion and removal of the development unit.

Another object of the present invention is to provide an image forming device that makes it possible to prevent mis-operation when fitting the drum unit and the development unit.

### SUMMARY OF THE INVENTION

The image forming device of the invention relating to claim 1 comprises a drum unit comprising a photosensitive drum and a development unit comprising a development sleeve disposed opposite the photosensitive drum when the units are coupled as separate components, wherein the drum unit and the development unit are each detachable from the image forming device main body.

This image forming device is configured such that a guide groove guiding the drum unit to a predetermined fitting position and a guides surface roughly parallel to the guide groove that guides the development unit to a predetermined fitting position are formed on the image forming device main body, a guide projection that fits into and moves along the guide groove is provided on the drum unit, and a development support part that is supported by and moves along the guide surfaces is provided on the development unit.

According to the invention relating to claim 1, a guide groove that guides the drum unit and guide surface that supports the development unit are formed in the image forming device man body, a guide projection that fits into and moves along the guide groove is provided on the drum unit, and a development support part that is supported by and moves along the guide surface is provided on the development unit. When the development unit is inserted into the image forming device main body, it is sufficient simply to set the development support parts onto the guide surfaces and slide them. This improves the operability of the development unit, which is frequently removed at time of addressing paper jam or other such operation.

The invention relating to claim 2 is an image forming device according to claim 1, wherein the guide surface is formed more inwardly in the unit insertion width direction than the guide groove.

According to the invention relating to claim 2, mis-insertion is prevented with the following constitution. The unit insertion widths of the guide groove and of the guide surface are different, preventing the fitting of the guide projection on the drum unit onto the guide surface or the insertion of the development support part of the development unit into the guide groove.

The image forming device of the invention relating to claim 3 comprises a drum unit comprising a photosensitive drum and a development unit comprising a development sleeve that is disposed opposite the photosensitive drum when the units are coupled, wherein the drum unit and development unit are separate components, and the drum unit and the development unit are each detachable from the image forming device main body.

Formed in the image forming device main body are a first guide groove, which guides the drum unit into a predetermined fitting position, and second guide groove roughly parallel to the first guide groove that guides the development unit into a predetermined fitting position. Provided on the drum unit are first guide projection that engages with the first guide groove and moves along the first guide groove, and provided on the development unit is a second guide projection that engages with the second guide groove and moves along the second guide groove. The first guide groove and the second guide groove have different unit insertion widths, and the first guide projection and the second guide projection have different diameters.

According to the invention relating to claim 3, mis-insertion of the drum unit and development unit into the image forming device main body can be prevented, because the unit insertion widths of the first guide groove, which guides the drum unit, and of the second guide groove, which guides the development unit, are different, and because the first guide projection provided on the drum unit, and the second guide projection provided on the development unit have different diameters.

The invention relating to claim 4 is the image forming device according to claim 3, wherein the unit insertion width of the first guide groove is greater than the unit insertion width of the second guide groove, and the diameter of the first guide projection is smaller than the diameter of the second guide projection.

According to the invention relating to claim 4, because the unit insertion width of the first guide groove is greater than the unit insertion width of the second guide groove, and the diameter of the first guide projection is smaller than the diameter of the second guide projection, the difference in unit insertion width of the first and second guide groove and the difference in diameter between the first and second guide projection are obvious, effectively preventing mis-insertion of the units.

### BRIEF DESCRIPTION OF THE DRAWINGS

FIG. 1 is a cross-sectional side view of an image forming device;

FIG. 2 is an external view of the above when the front cover is open;

FIG. 3 is an external view of the main body frame with guide grooves and guide surfaces formed thereupon;

FIG. 4 is a side view of the main body frame with guide grooves and guide surfaces formed thereupon;

FIG. 5 is an external view of the state of the drum unit fitted in the image forming device main body;

FIG. 6 is an external view of the state of the development unit fitted in the image forming device main body;

FIG. 7 is a partial side view of the development unit;

FIG. 8 is an external view of the state of the drum unit and the development unit fitted in the image forming device main body;

FIG. 9 is a cross-sectional side view of the state of the drum unit and the development unit fitted in the image forming device main body;

FIG. 10 is an external view of the state of the development unit fitted in the image forming device main body;

FIG. 11 is an external view of the development unit inserted into the image forming device main body;

FIG. 12 is an external view of the state of the drum unit and the development unit fitted in the image forming device main body;

FIG. 13 is a plan view of the state of the drum unit and the development unit fitted in the image forming device main body;

FIG. 14 is a lateral view of the state of first and second guide groove formed in the main body frame;

FIG. 15 is a plan view of the drum unit and development unit;

FIG. 16 is an external view of the drum unit inserted into the image forming device main body;

FIG. 17 is a plan view of the drum unit inserted into the image forming device main body;

FIG. 18 is a plan view of the development unit inserted into the image forming device main body; and

FIG. 19 is an external view of the state of the drum unit and development unit fitted in the image forming device main body.

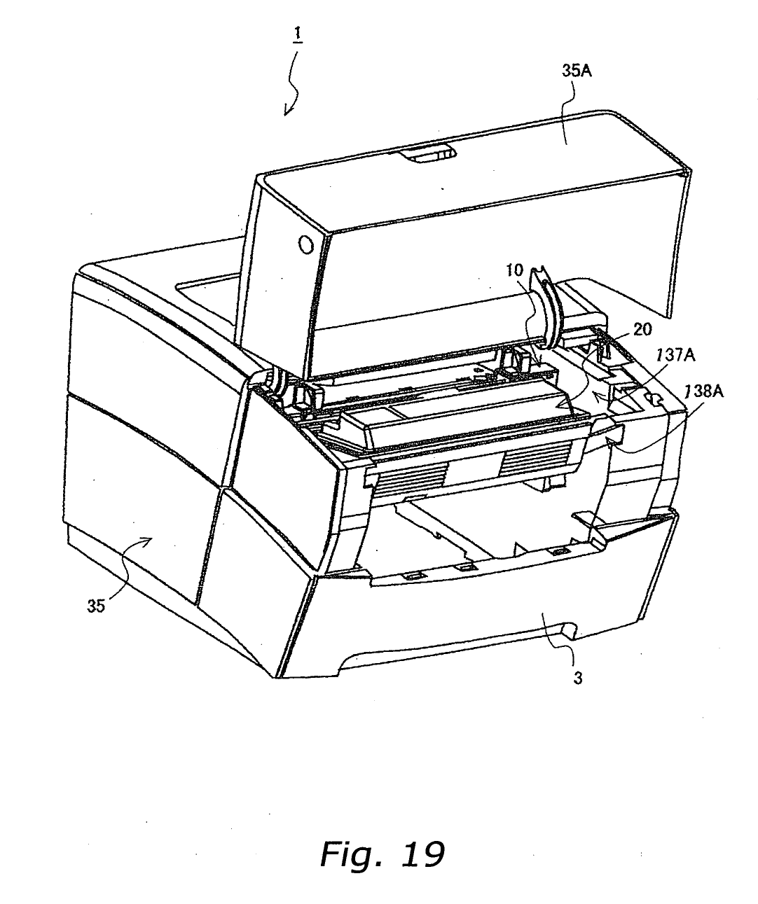

### DETAILED DESCRIPTION OF THE PREFERRED EMBODIMENTS

Embodiments of the present invention will be explained with reference to the drawings.

Overall configuration of the image forming device

### First Embodiment

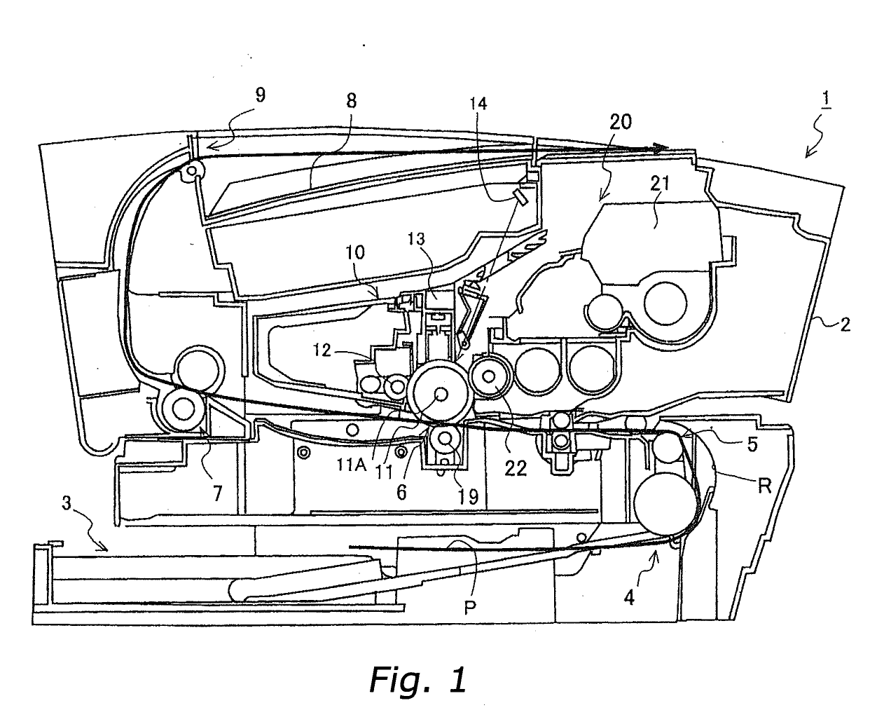

FIG. 1 is a lateral cross-sectional view of the image forming device according to an embodiment of the present invention.

In this drawing, an image forming device 1 comprises, in an image forming device main body 2, a paper feeding unit 4, which feeds sheets of recording material P from a paper feeding tray 3, a sheet transport unit 5, which transports recording material P fed from the paper feeding unit 4 along sheet transport route R, an image forming unit 6, which transfers a toner image to the recording material P that is transported by the sheet transport unit 5, a fixing device 7, which fixes on the recording material P the toner image transferred thereupon by this image forming unit 6, and an ejection unit 9, which ejects into paper ejection tray 8 the recording material P onto which the toner image has been fixed by this fixing device 7. Examples of the recording material P include paper, plastic film, overhead projector transparencies, and the like.

The image forming unit 6 comprises a drum unit 10 having a photosensitive drum 11 and a development unit 20 having a development sleeve 22 (described below), and a transfer roller 19, which transfers the toner image on the surface of the photosensitive drum 11 onto the recording material P. The drum unit 10 and the development unit 20 are constituted as separate unit, and each is detachable from the image forming device main body 2.

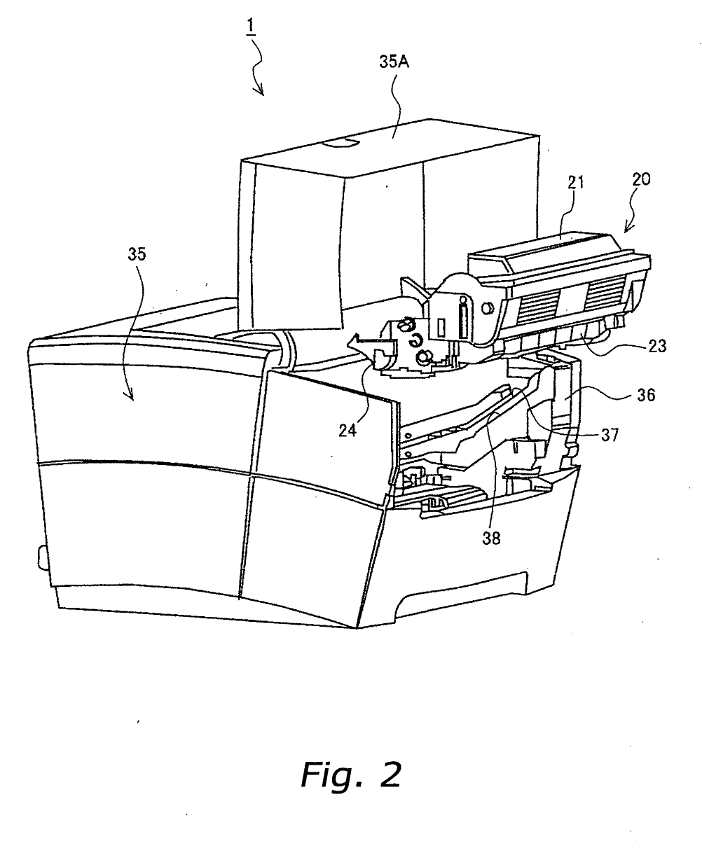

The image forming device main body 2 is covered by an outer cover 35 (see FIG. 2), and opening the front cover 35A (see FIG. 2) allows the drum unit 10 and the development unit 20 to be inserted into and removed from the image forming device main body 2.

<Configuration of the Drum Unit>

As shown in FIG. 1, the drum unit 10 comprises the photosensitive drum 11, which faces and is below the development unit 20 when the units are coupled together. The photosensitive drum 11 is rotatably supported in the drum unit 10 by a drum shaft 11A. Arranged around the photosensitive drum 11 are a cleaner 12, which removes toner remaining on the surface of the photosensitive drum 11, a charger 13, which puts a uniform electrostatic charge on the surface of the photosensitive drum 11, and a decharger (not shown in the figures) that removes the residual electric charge. In addition, laser light can be beamed from an exposure device 14 onto the photosensitive drum 11. Also, the drum unit 10 is inserted into and fitted in the image forming device main body 2 along the guide groove 37 provided on the side of main body frame 36 (see FIG. 2).

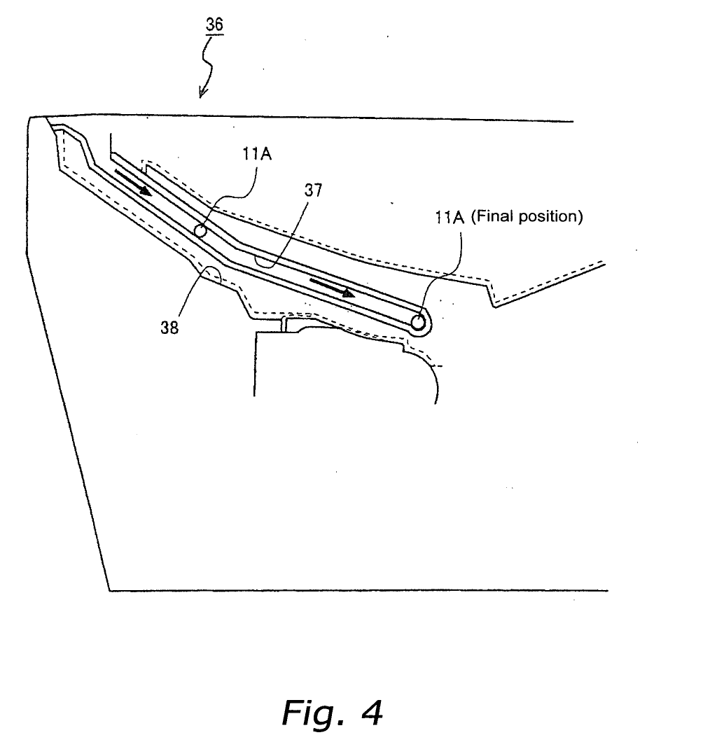

That is, when the drum unit 10 is inserted into the image forming device main body 2, the drum shaft 11A as a guide projection of the photosensitive drum 11 is guided and supported along the guide groove 37, which is formed in the main body frame 36 on both ends in the unit insertion width direction (drum axial direction). Formed at the end of the guide groove 37 in the insertion direction are final positioning points (see FIG. 4) of the drum unit 10. The drum unit 10 comprises, on drum shaft 11A of the photosensitive drum 11, a rotation-driven gear (not shown in the figures) that meshes with a rotation-drive gear (not shown in the figures) provided on the image forming device main body 2.

<Configuration of the Development Unit>

FIG. 2 is a schematic oblique view of the image forming device in a case where the development unit 20 is to be inserted after that the drum unit 10 has been inserted.

The development unit 20 comprises at the lower part of the side facing the photosensitive drum 11, a development sleeve 22, which at time of fitting into the image forming device main body 2 faces the photosensitive drum 11 with a predetermined development gap therebetween. This development sleeve 22 supplies toner to the electrostatic latent image formed on the photosensitive drum 11, thus developing the image. A toner storage container 21, which stores toner that contains a magnetic substance, is provided in a position in the development unit 20 opposite the side facing the photosensitive drum 11. A rear wall 23 that protrudes downward is formed on the lower part of this toner storage container 21.

At both ends in the sleeve axial direction of the development unit 20 there is provided a development support part 24 that protrudes sideward (in the sleeve axial direction). And at both ends in the unit insertion width direction of the main body frame 36 of the image forming device main body 2 is a guide surface 38 roughly parallel to the guide groove 37. The development unit 20 is inserted into the image forming device main body 2 with the development support parts 24 supported on the guide surface 38. In a state of insertion into image forming device main body 2, the development unit 20 is pressed toward the drum unit 10 by pressing means 30, which is described below.

<Configuration of the Main Body Frame>

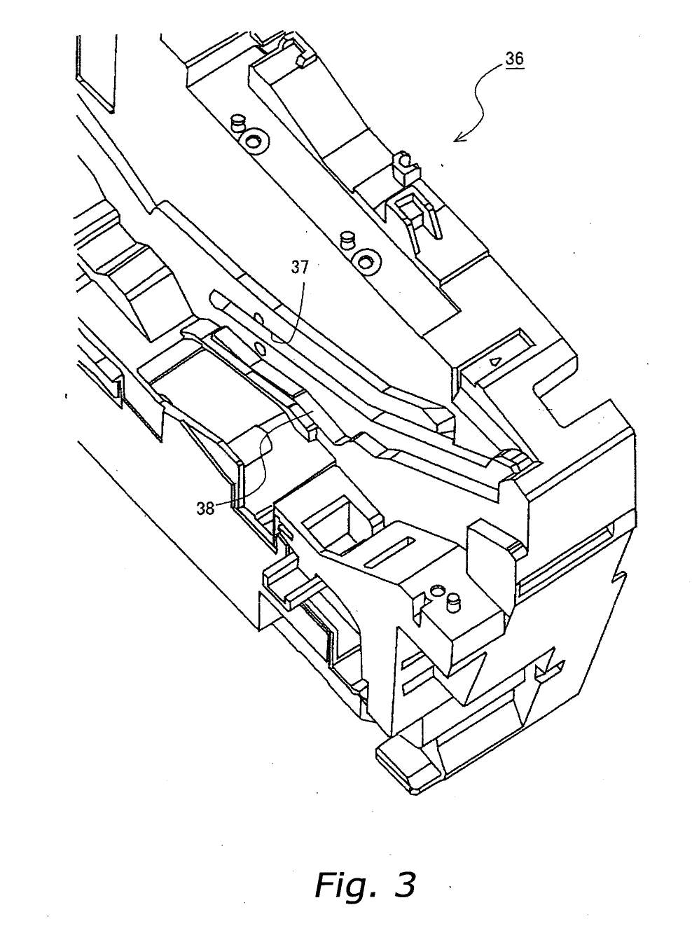

As shown in FIG. 2, one pair each of the guide groove 37 and guide surface 38 are formed on the main body frame 36. Specifically, as shown in FIG. 3 and FIG. 4, the guide groove 37 is formed in a groove shape in the main body frame 36, the drum shaft 11A of the photosensitive drum 11 is restricted in vertical motion by the guide groove 37 and is guided thereby to its predetermined fitting position (final position).

The guide surface 38 is formed in a shape having steps at a position below and more inwardly in the unit insertion width direction than the guide groove 37. This guide surface 38 is constituted to support the development support part 24 of the development unit 20, and the space above the guide surface 38 is open. With such a constitution, to insert the development unit 20 into the image forming device main body 2, in a state with the development support part 24 resting on the guide surface 38, the development unit 20 is slid and guided to its predetermined fitting position.

As stated above, the guide surface 38 is formed more inwardly than the guide groove 37 in the unit insertion width direction, so the unit insertion width of the guide groove 37 is greater than the unit insertion width of the guide surface 38. Therefore, when the drum unit 10 is to be inserted into the image forming device main body 2, the drum shaft 11A of the drum unit 10 cannot be placed onto the guide surface 38 by mistake, because the unit insertion width of the guide surface 38 is smaller. Because the unit insertion width of the guide groove 37 is larger, the development support part 24 of the development unit 20 cannot be inserted into the guide groove 37 by mistake. Thus, mis-insertion is prevented.

<Operation of the Guide Grove and Guide Surface>

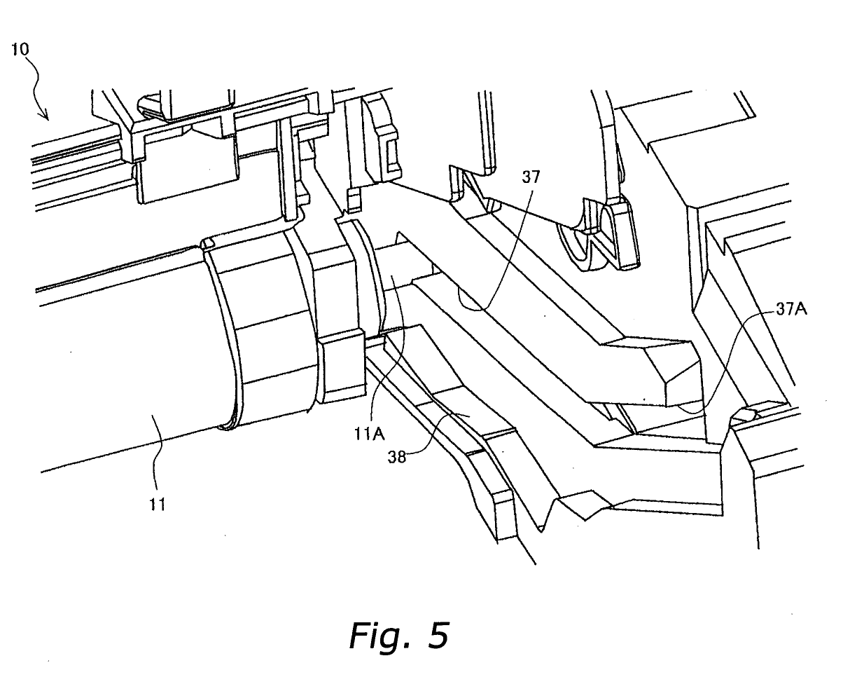

FIG. 5 shows the state of the drum unit 10 inserted into the image forming device main body 2 to its final position. More specifically, the drum shaft 11A of the photosensitive drum 11 has been inserted through the opening 37A of the guide groove 37, and, while moving within the guide groove 37, has been guided to the final position inside the image forming device main body 2.

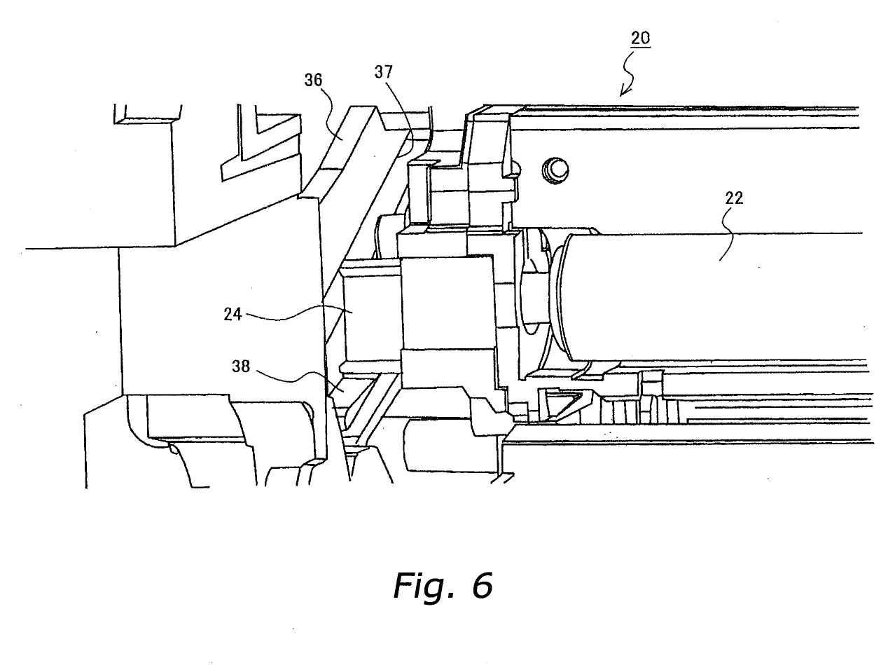

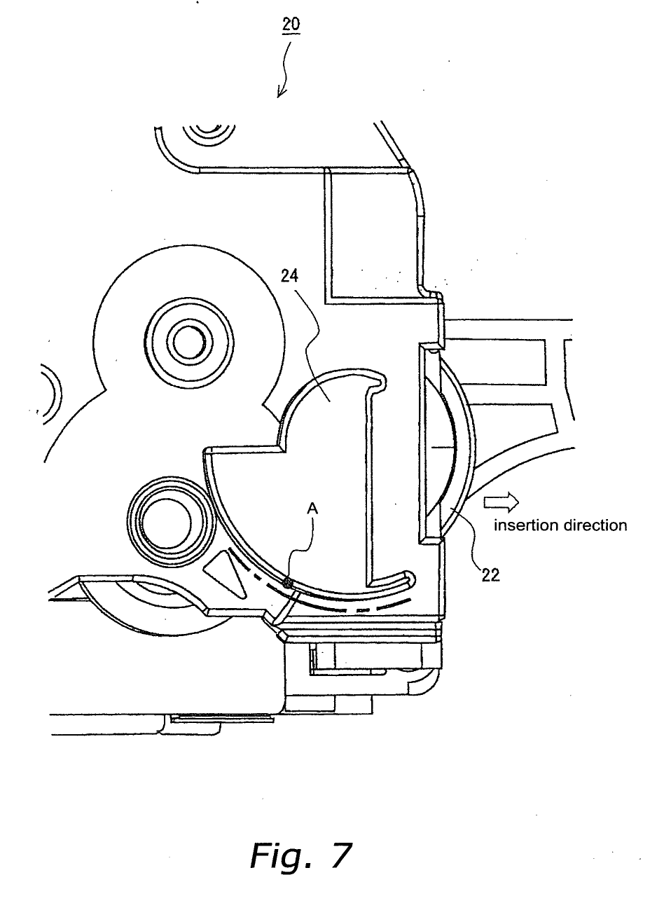

FIG. 6 shows a state where the development unit 20 has been inserted to its final position inside the image forming device main body 2, and FIG. 7 shows an enlarged view of the side of the development unit 20. A development support part 24 is provided at each of the two ends of the development unit 20 in the sleeve axial direction, and the side that comes into contact with the guide surface 38 is formed in an arc. When the development unit 20 is inserted into the image forming device main body 2, it comes into contact with the guide surface 38 in the range indicated by the alternating long and short dashed line in FIG. 7, and at its final stopping position, it is in linear contact near point A in FIG. 7.

In this way, upon insertion of the development unit 20 into the image forming device main body 2, the development support part 24 can be inserted into the image forming device main body 2 and guided to its predetermined final position simply by placing it onto the guide surface 38 from above and sliding. However, because the development unit 20 is slid in a state of resting on the guide surface 38, when it is fitted in its final position inside the image forming device main body 2, there must be means for pushing toward the drum unit 10 and means for pressing down to ensure that the development unit 20 does not escape upward.

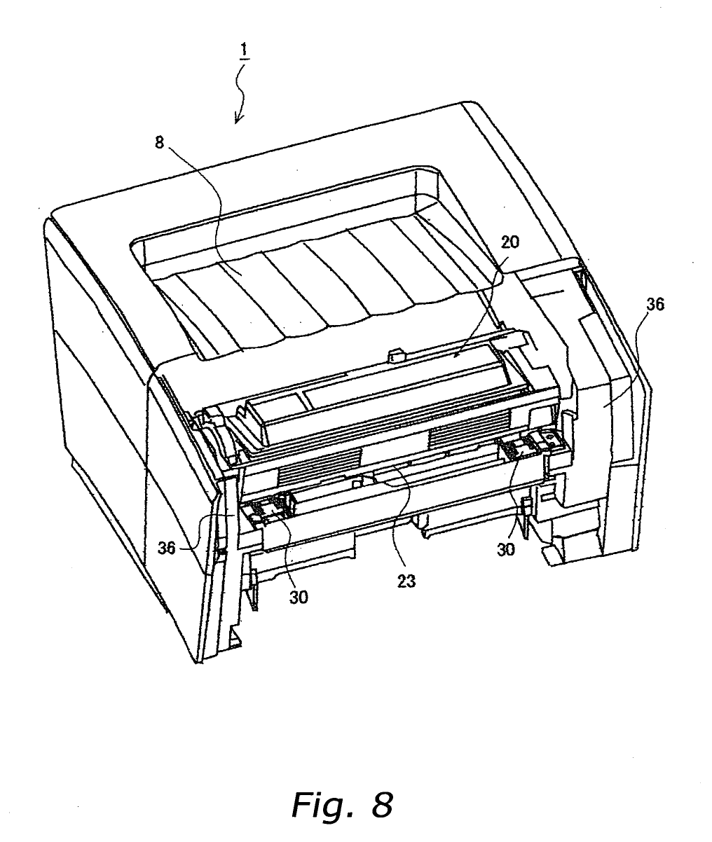

Thus according to the configuration shown in FIG. 8 through FIG. 10, the development unit 20 is pressed toward the drum unit 10 and prevented from escaping upward.

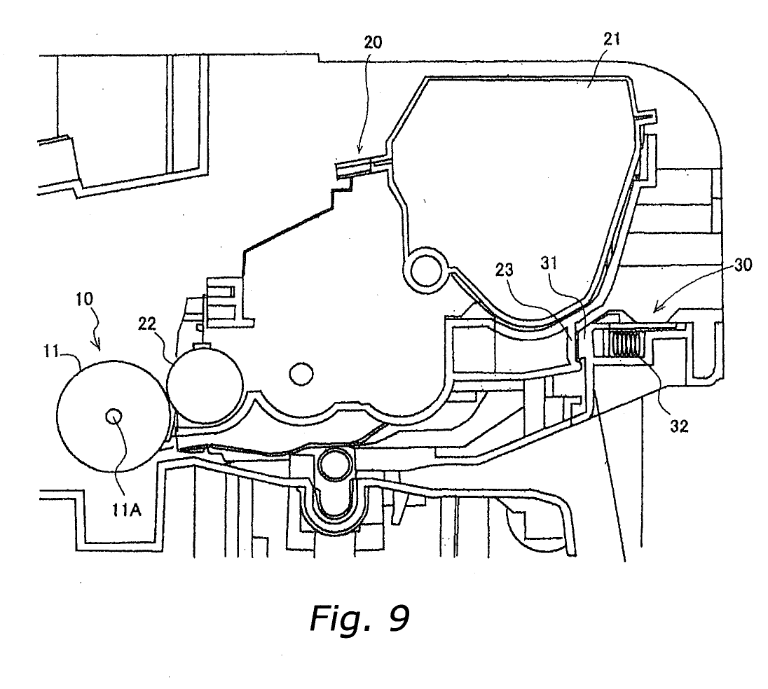

First, in FIG. 8 and FIG. 9, pressing means 30 having a pressing member 31 and a spring 32 is provided on the unit insertion opening side of image forming device main body 2. The pressing member 31 is provided slidingly in the unit insertion direction (the front-rear direction) with respect to the image forming device main body 2, and the pressing member 31 is impelled toward the front by the impelling force of the spring 32. As described above, the rear wall 23 protrudes downward below the toner storage container 21, and this rear wall 23 is made to come into contact with the pressing member 31. Because of this, the development unit 20 is pressed toward the drum unit 10 through the rear wall 23 by the impelling force of the spring 32.

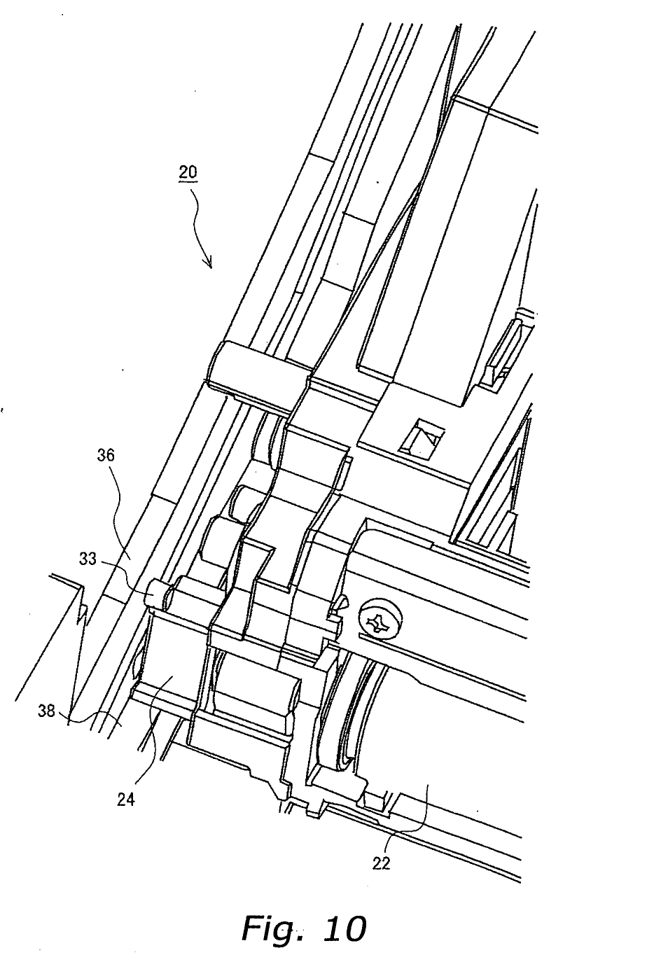

In FIG. 10, a boss is provided in a manner projecting inwardly in the unit insertion direction from the main body frame 36 at a position near its final position when the development unit 20 has been inserted into the image forming device main body 2. With the development unit 20 inserted into the image forming device main body 2 and fitted into its final position, the upper edge face of the development support part 24 is in contact with the boss 33. Thus in a state where the development unit 20 is fitted into the image forming device main body 2, the development unit 20 is prevented from escaping upward.

Thus with such a configuration, for insertion of the development unit 20 into the image forming device main body 2, it is sufficient simply to set the development support part 24 onto the guide surface 38 from above and slide, so as with the drum unit 10, there is no need for a complicated operation such as, for example, making a development support part 24 match with a groove.

Such a configuration improves the operability of the development unit 20, which is frequently removed from the image forming device main body 2 because of paper jams or other such reason. Because the drum unit 10 is guided by the guide groove 37 and the development unit 20 is placed onto the guide surface 38 and is guided, operations are easily explained.

### Second Embodiment 2

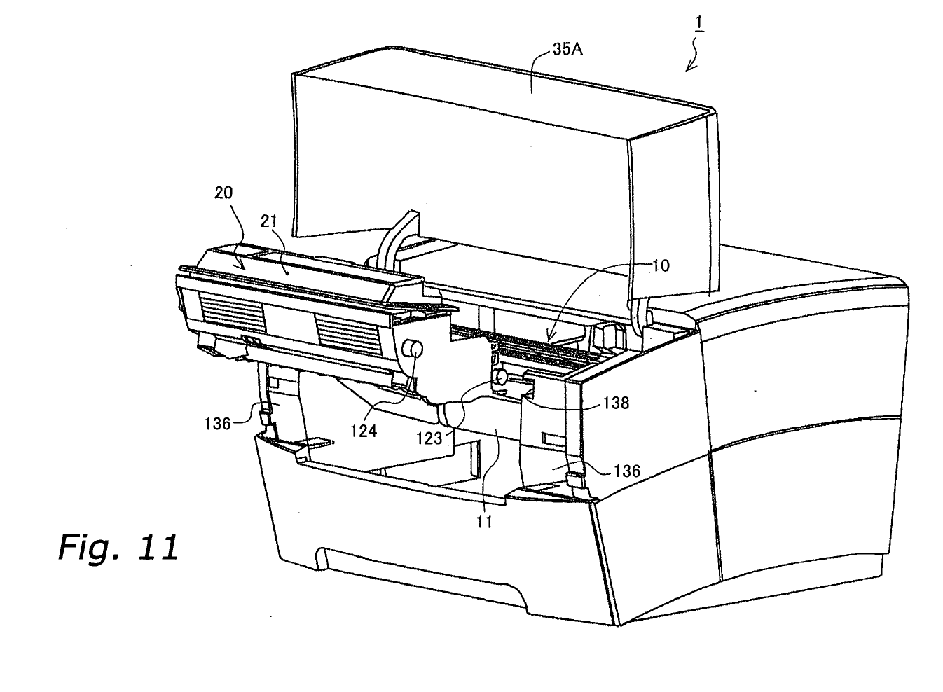

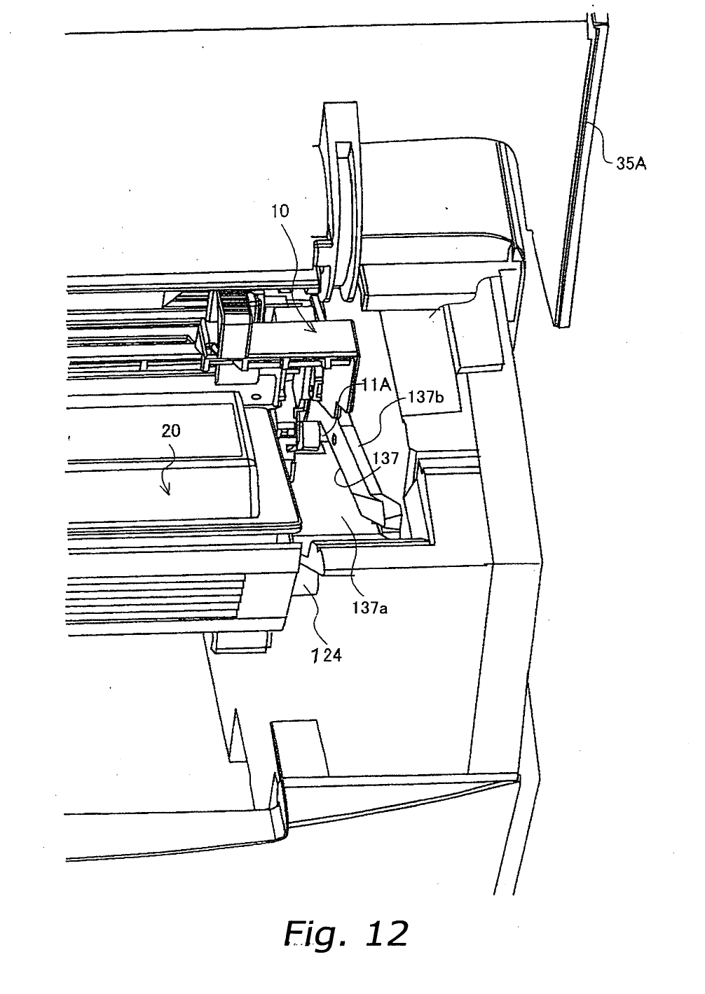

An explanation will now be given of a second embodiment. The overall configuration of the image forming device in this second embodiment is the same as the configuration of the first embodiment shown in FIG. 1. FIG. 11 is a schematic oblique view of a case of an imaging forming device where after the drum unit 10 has been inserted, the development unit 20 is to be inserted into image forming device main body 2, and FIG. 12 is a perspective view of a state where the drum unit 10 and the development unit 20 have been inserted.

In FIG. 11 and FIG. 12, the image forming device main body 2 is covered by an outer cover 35, and when a front cover 35A thereof is opened, the drum unit 10 and the development unit 20 can be inserted into or removed from the image forming device main body 2.

<Configuration of the Drum Unit>

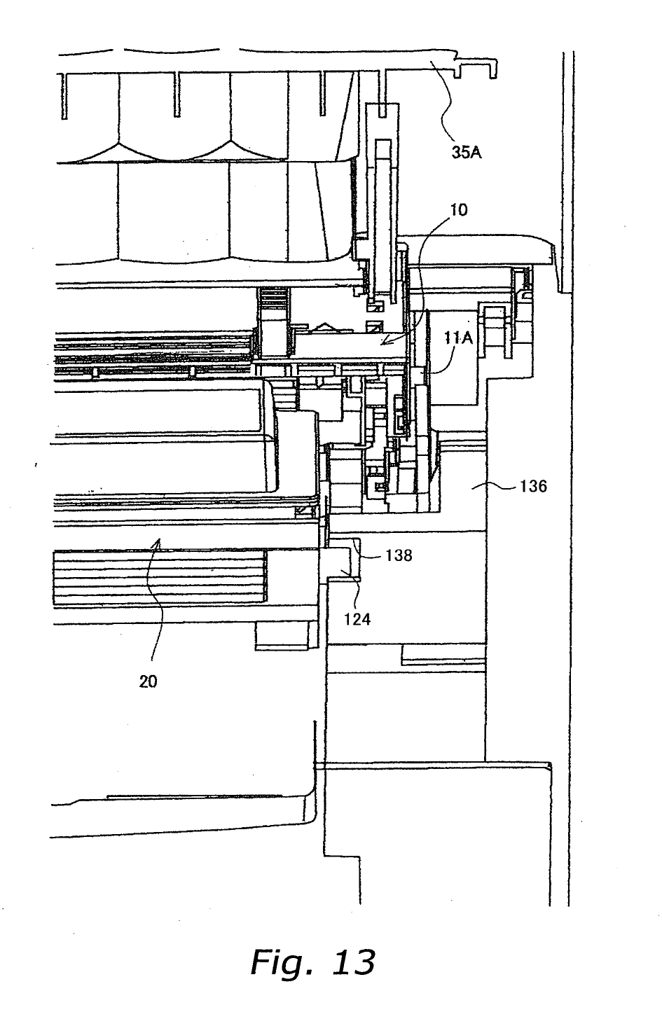

As shown in FIG. 1 and FIG. 11 to FIG. 13, the drum unit 10 comprises the photosensitive drum 11 on the lower part of the side opposite the development unit 20 when the units are coupled together. This photosensitive drum 11 is rotatably supported rotatably on the drum unit 10 by a drum shaft 11A as a first guide projection. Provided in the vicinity of the photosensitive drum 11 are a cleaner 12, which removes toner remaining on the surface of the photosensitive drum 11, a charger 13, which puts a uniform electrostatic charge on the surface of the photosensitive drum 11, and a decharger (not shown in the figures) that removes the residual electric charge. In addition, laser light can be beamed from the exposure device 14 onto the photosensitive drum 11. The drum unit 10 can be inserted into the image forming device main body 2 along a first guide groove 137 provided on a main body frame 136 described below.

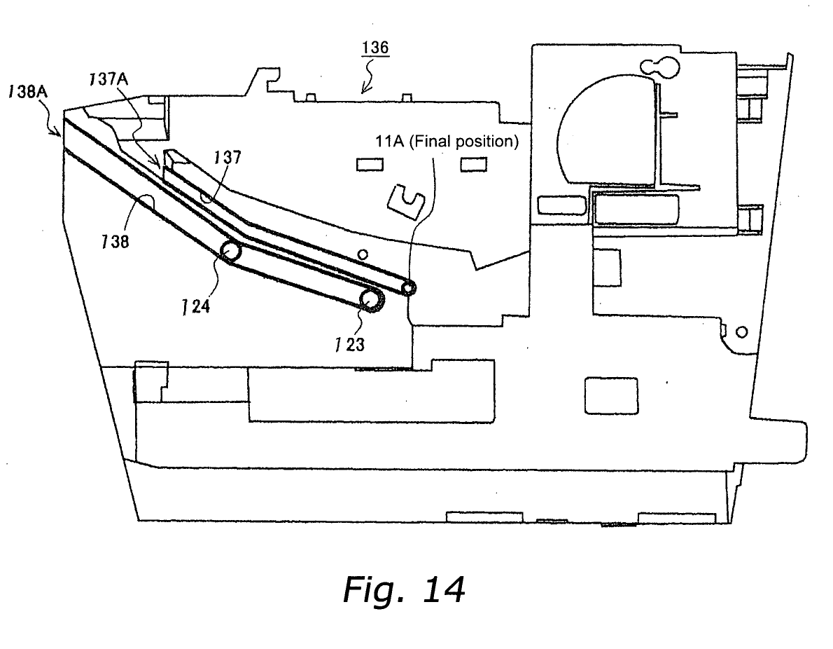

For example, when the drum unit 10 is to be inserted into the image forming device main body 2, the drum shaft 11A of the photosensitive drum 11 is guided along a first guide groove 137 formed on both ends in the unit insertion width direction (the drum axial direction) of the main body frame 136. At the end of the first guide groove 137 in the insertion direction is a final positioning point (see FIG. 14) of the drum unit 10. Further, the drum shaft 11A of the photosensitive drum 11 is given a diameter allowing smooth entry into the first guide groove 137.

In the drum unit 10, rotation-driven gears (not shown in the figures) that mesh with rotation-drive transmission gears (not shown in the figures) provided on the image forming device main body 2 side are provided on the drum shaft 11A of the photosensitive drum 11.

<Configuration of the Development Unit>

As shown in FIG. 1 and FIG. 11 to FIG. 13, the development unit 20 comprises, at a lower portion of the side that faces the photosensitive drum 11, a development sleeve 22, which faces the photosensitive drum 11 with a predetermined development gap therebetween when the development unit 20 is fitted into the image forming device main body 2. This development sleeve 22 carries out development by supplying toner to the electrostatic latent image formed on the photosensitive drum 11. Provided in a position opposite the side facing the photosensitive drum 11 in the development unit 20 is a toner storage container 21, which stores toner that includes a magnetic substance.

Provided on both ends of the development unit 20 in the sleeve axial direction are guide pins 123 and 124 (one pair each on left and right) as second guide projections that protrude sideward (in the sleeve axial direction). A second guide groove 138, roughly parallel to the first guide groove 137 referred to above, is formed on the main body frame 136 on both ends in the unit insertion width direction of the image forming device main body 2. The unit insertion width of the first guide grooves 137 is greater than the unit insertion width of the second guide grooves 138.

The development unit 20, when fitted into the image forming device main body 2, is guided with the guide pins 123 and 124 in the second guide groove 138. The guide pins 123 and 124 may, for example, have the same diameter, which is of a size that smoothly fits into the second guide groove 138. In addition, these guide pins 123 and 124 have a greater diameter than that of the drum shaft 11A of the photosensitive drum 11.

The above explanation assumes that two guide pins 123 and 124 are protrusions provided on the development unit 20, but it is also permissible to have just one of these guide pins.

<Configuration of the Guide Grooves and Guide Projections>

As shown in FIG. 14, one pair each of a first guide groove 137 and second guide groove 138 are formed in the above-described main body frame 136. That is, as shown in FIG. 12 to FIG. 14, the first guide groove 137 has a wide support surface 137a, on which the drum shaft 11A of the photosensitive drum 11 is placed, and a guide member 137b, which covers the upper surface of drum shaft 11A so as to come in contact therewith at the end of this support surface 137a in the unit insertion width direction. The drum shaft 11A of the photosensitive drum 11, while making contact with the upper and lower surfaces of this first guide groove 137, is guided as far as the predetermined fitting position (final position).

The second guide groove 138, having a three-sided box cross-sectional shape, is formed roughly parallel to the first guide groove 137, below and more inwardly in the unit insertion width direction than the first guide groove 137. Because of this, in inserting the development unit 20 into the image forming device main body 2, the guide pins 123 and 124 are inserted into the guide groove 138, and in such a state the development unit 20 is slid and guided to its predetermined fitting position.

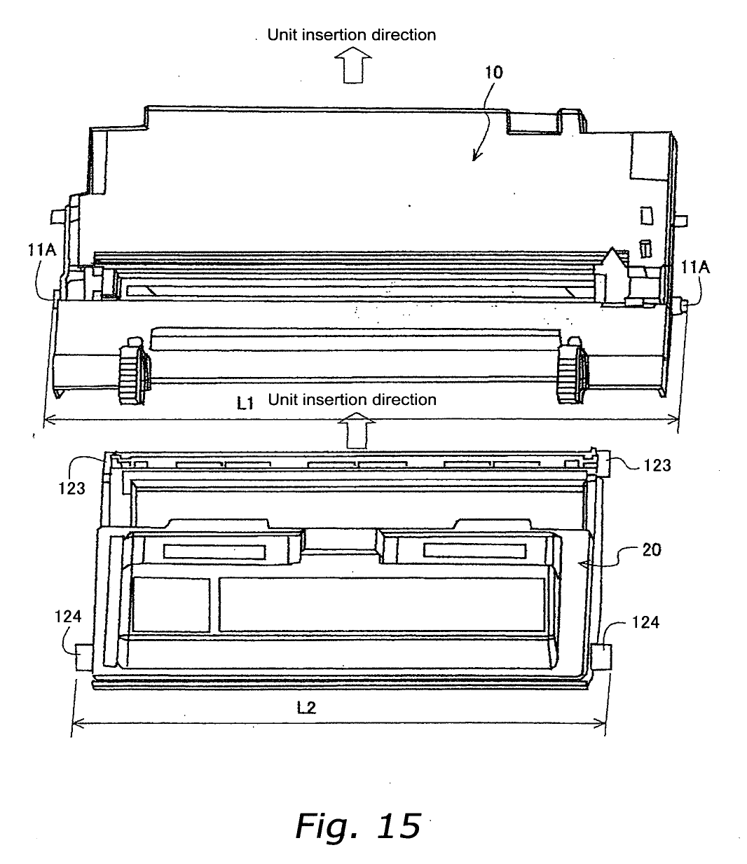

As shown in FIG. 15, the diameter of the drum shaft 11A of the drum unit 10 is smaller than the diameter of the diameter of the guide pins 123 and 124 of the development unit 20. And correspondingly, the groove diameter of first guide groove 137 is smaller than the groove diameter of second guide groove 138 (see FIG. 14).

Such a constitution makes it impossible to mistakenly put the large-diameter guide pins 123 and 124 of the development unit 20 into the small-groove-diameter first guide groove 137, preventing mis-insertion of the development unit 20 into the image forming device main body 2. Even so, there still remains the danger that the small-diameter drum shaft 11A of the drum unit 10 will be misinserted into the large-groove-diameter second guide groove 138. Thus, as shown in FIG. 15, length L1 of the drum unit 10 in the axial direction of the drum shaft 11A is longer than length L2 of the development unit 20 in the axial direction of the guide pins 123 and 124.

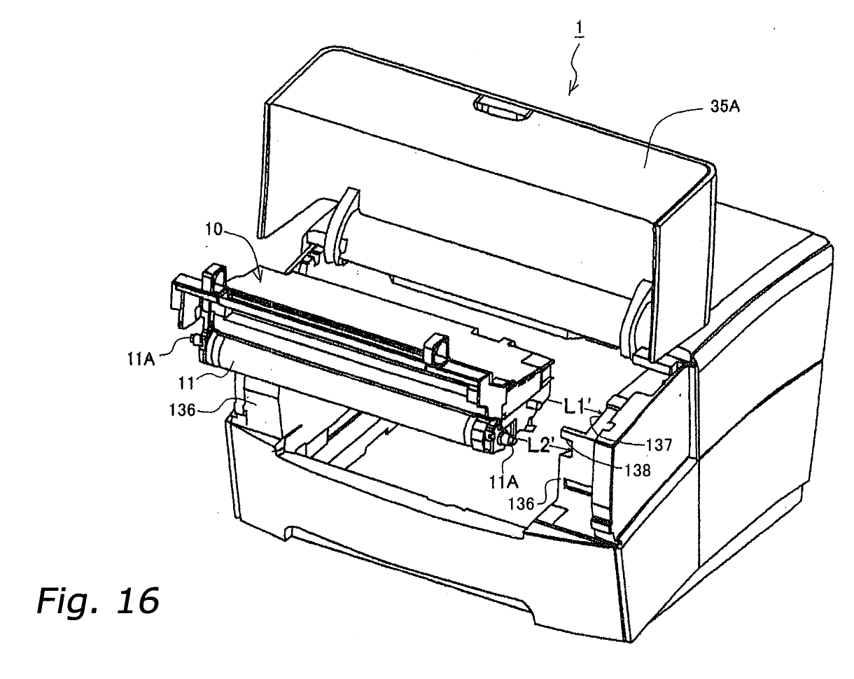

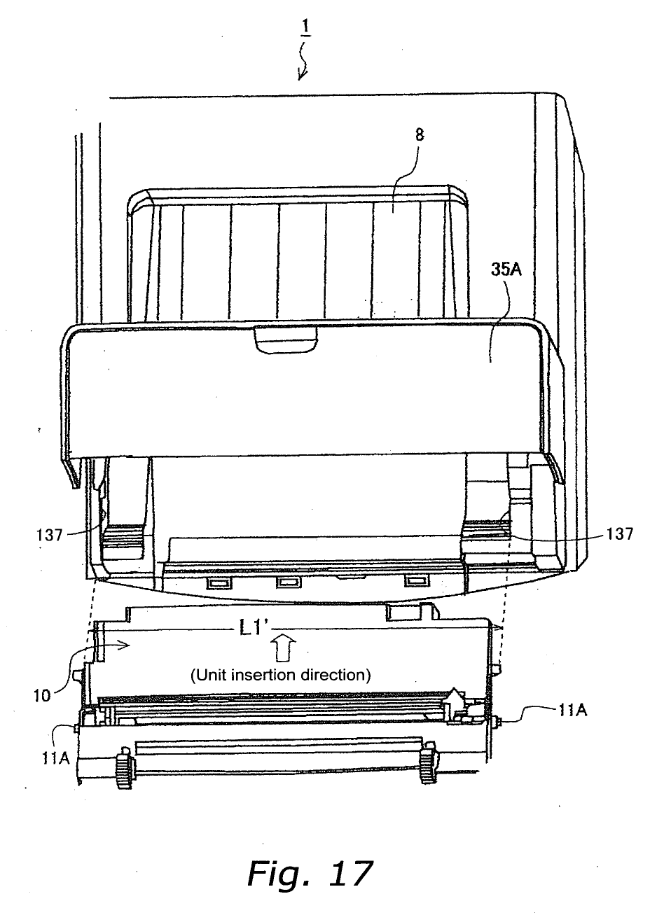

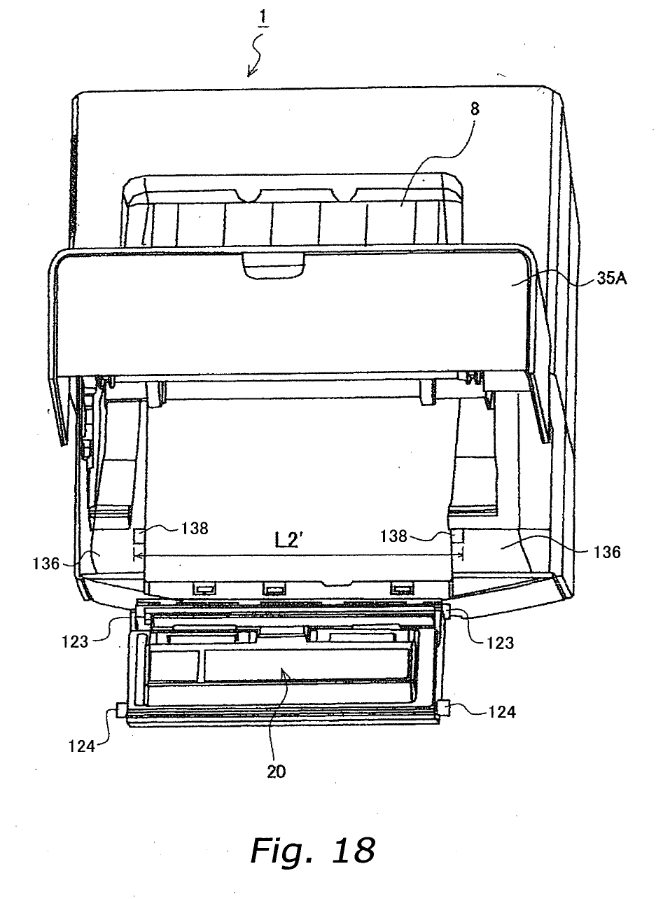

FIG. 16 and FIG. 17 show a state where the drum unit 10 is to be inserted into the image forming device main body 2, and FIG. 18 shows a state where the development unit 20 is to be inserted into the image forming device main body 2.

In FIG. 16 to FIG. 18, so as to correspond with the length L1 of the drum unit 10 in the axial direction of the drum shaft 11A and the length L2 of the development unit 20 in the axial direction of the guide pins 123 and 124, the unit insertion width L1′ of the first guide groove 137 along which the drum unit 10 is guided into the image forming device main body 2 is made larger than the unit insertion width L2′ of the second guide groove 138 along which the development unit 20 is guided into the image forming device main body 2.

Thus when inserting the drum unit 10 into the image forming device main body 2, because the insertion widths of units 10 and 20 are different, it is impossible to mistakenly put the drum shaft 11A of the drum unit 10 into the second guide groove 138. And when inserting the development unit 20 into the image forming device main body 2, because the unit insertion widths are different and the diameter of the guide pins 123 and 124 is greater than the groove diameter of the first guide groove 137, it is also impossible to mistakenly put the guide pins the 123 and 124 of the development unit 20 into the first guide grooves 137. Thus mis-insertion of the drum unit 10 and the development unit 20 into the image forming device main body 2 is prevented.

When inserting either the drum unit 10 or the development unit 20 into the image forming device main body 2, an operator can easily confirm the difference between the unit insertion width of the first guide groove 137 and the unit insertion width of the second guide groove 138, and moreover can easily confirm the difference between the diameters of the drum shaft 11A and of the guide pins 123 and 124. This allows the operator to insert the drum unit 10 and the development unit 20 into the image forming device main body 2 without error, each from the correct insertion openings.

FIG. 10 shows a state where the drum unit 10 and the development unit 20 have been inserted as far as their final position inside the image forming device main body 2. That is, the drum shaft 11A of the photosensitive drum 11 is inserted through the opening 137A of the first guide groove 137 (see FIG. 14) and is guided along the first guide groove 137 as far as its final position inside the image forming device main body 2. And the guide pins 123 and 124 of the development unit 20 are inserted through the opening 138A of second guide groove 138 (see FIG. 14) and are guided along the second guide groove 138 as far as their final positions inside the image forming device main body 2.

What is claimed is:

1. An image forming device in which a drum unit comprising a photosensitive drum and a development unit comprising a development sleeve disposed opposite the photosensitive drum when the units are coupled together are constituted as separate components, the drum unit and the development unit each being detachable from the image forming device main body, wherein:
a guide groove that guides the drum unit to a predetermined fitting position and a guide surface roughly parallel to the guide groove that guides the development unit to a predetermined fitting position are formed in the image forming device main body, and
guide projections that fit into and move along the guide groove are provided on the drum unit, and development support parts that are supported on and move along the guide surface are provided on the development unit.

2. An image forming device according to claim 1 wherein:
the guide surface is formed more inwardly in the unit insertion width direction than the guide groove.

3. An image forming device in which a drum unit comprising a photosensitive drum and a development unit comprising a development sleeve disposed opposite the photosensitive drum when the units are coupled together are constituted as separate components, and the drum unit and the development unit are each detachable from the image forming device main body, wherein:
formed in the image forming device main body are a first guide groove that guides the drum unit to a predetermined fitting position, and second guide groove roughly parallel to the first guide groove that guides the development unit into a predetermined fitting position,
provided on the drum unit is a first guide projection that engages with the first guide groove and moves along the first guide groove, and provided on the development unit is a second guide projection that engages with the second guide groove and moves along the second guide groove, and
the unit insertion widths of the first and second guide grooves are different, and the diameters of the first and second guide projections are different.

4. An image forming device according to claim 3 wherein:
the unit insertion width of the first guide groove is greater than the unit insertion width of the second guide groove, and
the diameter of the first guide projection is smaller than the diameter of the second guide projection.
